(19) United States
(12) Patent Application Publication
(10) Pub. No.: US 2015/0289507 A1
(43) Pub. Date: Oct. 15, 2015

(54) NATURALLY DERIVED NEMATICIDE COMPOSITIONS

(71) Applicant: Lidag, S.A. de C.V.

(72) Inventor: Antonio Muñoz Santiago, Houston, TX (US)

(73) Assignee: Lidag, S.A. de C.V.

(21) Appl. No.: 14/252,641

(22) Filed: Apr. 14, 2014

(51) Int. Cl. A01N 43/16; A01N 65/08; A01N 31/16

(52) U.S. Cl. CPC A01N 43/16; A01N 31/16; A01N 65/08

(57) ABSTRACT

Nematicidic emulsions include water, a base thickener, an emulsifying agent, saponins and catechols, and glucosinolates. The ratio of amount of saponins and catechols to glucosinolates can be in the range from 20:1 to 1:5. Exemplary amounts of water are from about 1% to about 99% of the total volume of the emulsion. An exemplary amount of base thickener would be about 0.01% to about 6.0% of the total volume of the emulsion. The base thickener can include xanthan gum.

### BACKGROUND OF THE INVENTION

1. Field of the Invention

Development of a new organic nematicide based on plant extracts for the control of nematodes, such as Meloidogyne incognita, in economically important crops to reduce the use of chemical pesticides

2. Description of the Related Art

Botanical pesticides are biodegradable and their use in plant protection is a sustainable, alternative practice. Biodiversity protects against predators and reduces environmental pollution and human health risks. Research on the active ingredients, pesticide preparations, rates of application, and environmental impact of botanical pesticides are a prerequisite for sustainable agriculture. Botanical Pesticides are unique because of their physical and chemical properties. As consumer demand grows for organically produced food, scientific research on the use of botanical pesticides should address these needs.

Traditional methods of addressing this problem in orchards have focused on the use of chemical nematicidas. But such products can have adverse effects not only on wildlife and humans but can also harm agricultural ecosystems. Moreover, they are generally expensive.

### SUMMARY OF THE INVENTION

According to some embodiments of the present disclosure, there is disclosed a nematicidic emulsion that includes water, a base thickener, an emulsifying agent, saponins and catechols, and glucosinolates. In some embodiments, the ratio of amount of saponins and catechols to glucosinolates is in the range from 20:1 to 1:5. In some embodiments, the water comprises from about 1% to about 99% of the total volume of the emulsion. In some embodiments, the base thickener comprises about 0.01% to about 6.0% of the total volume of the emulsion. And in some embodiments, the base thickener comprises xanthan gum.

According to some embodiments, the first emulsifying agent comprises about 0.05% to about 6% of the total volume of the emulsion. In some embodiments, the emulsifying agent includes a first emulsifying agent and a second emulsifying agent. In some embodiments, the first emulsifying agent comprises polysorbate 80. In some embodiments, the second emulsifying agent comprises about 0.2% to about 25% of the total volume of the emulsion. In some embodiments, the second emulsifying agent comprises monostearate sorbitol. And in some embodiments, the glucosinolates comprise about 0.5% to about 60% of the total volume of the emulsion. In some emulsions, the saponins and catechols comprise about 1.0% to about 90%.

According to some embodiments of the present disclosure, there is disclosed a packaged emulsion that includes a non-air tight, translucent enclosure; and a nematicide emulsion packaged inside the enclosure. In some embodiments, the nematicide emulsion includes water, a base thickener, an emulsifying agent, saponins and catechols, and glucosinolates. In some embodiments, the emulsion can also include at least polyethylenes, other glycosides, other alkaloids, lipids, catechins, terpenoids, steroids, phenols, or triterpenoids. In some embodiments, the emulsion includes nordihydroguaiaretic acid (NDGA).

According to some embodiments, the saponin is triterpene saponin. In some embodiments, the saponin is present in a first plant extract, which in some embodiments, is Larrea tridentata. In some embodiments, the glucosolinates are present in a second plant extract, which in some embodiments is Brassica Sp. In some embodiments, the base thickener includes xanthan gum. In some embodiments, the first emulsifying agent comprises polysorbate.

According to some embodiments, there is disclosed herein a method of making a nematicidic emulsion in which the emulsifying agent includes a first emulsifying agent and a second emulsifying agent, the method including providing water, adding the base thickener to the water to form a first mixture, agitating the first mixture, adding the saponins and catechols to the first mixture to form a second mixture, agitating the second mixture, adding the first emulsifying agent to the second mixture to form a third mixture, agitating the third mixture, adding the second emulsifying agent to form a fourth mixture, agitating the fourth mixture until the fourth mixture is substantially homogenous, adding the glucosinolates to the fourth mixture to form a fifth mixture; and stirring the fifth mixture until the emulsion is formed. In some methods, agitation is continuously applied. And in some methods, agitating of each of the first, second, third and fourth mixtures is performed for about 0.5 to about 50 minutes at about 100 rpm to about 10,000 rpm.

### BRIEF DESCRIPTION OF THE DRAWINGS

FIG. 1 is a graphical representation of the mortality rate achieved using a dilution of 1:10 for various nematicide samples.

FIG. 2 is a graphical representation of the mortality rate achieved using a dilution of 1:50 for various nematicide samples.

FIG. 3 is a graphical representation of the mortality rate achieved using a dilution of 1:100 for various nematicide samples.

FIG. 4 is a graphical representation of the mortality rate achieved using a dilution of 1:200 for various nematicide samples.

FIG. 5 is a graphical representation of the mortality rate achieved using a dilution of 1:500 for various nematicide samples.

FIG. 6 is a graphical representation of the mortality rate achieved using a dilution of 1:1000 for various nematicide samples.

FIG. 7 is a graphical representation of the mortality rate achieved using a dilution of 1:2000 for various nematicide samples.

FIG. 8 is a photograph of the roots of a plant affected by the root-knot nematode where the roots exhibit large nodules.

FIG. 9 is a photograph of different root systems, some of which were treated with different nematicides.

FIG. 10a is a photograph of a root system treated with a nematicide made according to the present disclosure.

FIG. 10b is a photograph of the root system of FIG. 10a that has been subjected to an acid treatment.

FIG. 11a is a photograph of a root system treated with a different nematicide.

FIG. 11b is a photograph of the root system of FIG. 11a that has been subjected to an acid treatment.

FIG. 12a is a photograph of a root system treated with a third nematicide.

FIG. 12b is a photograph of the root system of FIG. 12a that has been subjected to an acid treatment.

FIG. 13 is photograph of a root system of a plant not treated with any nematicide.

### DETAILED DESCRIPTION OF PREFERRED EMBODIMENTS

Disclosed herein are nematicides, nematicide compositions, methods of preparing nematicides and nematicide compositions, and methods of using nematicides and nematicide compositions. It will be understood that any features described herein may be used in combination with one or more of any other disclosed features. Moreover, the specific embodiments disclosed herein are merely exemplar embodiments of the present disclosure. No features are essential or indispensable.

Studies have shown that Brassica napa can reduce populations of plant parasitic nematodes and that this reduction is greater if the culture is incorporated as green stuff. This nematicidal activity is attributed to the production of toxic compounds when these plants are damaged or broken, where some compounds such as glucosinolates are responsible for this reaction. Glucosinolates are non-toxic until they come into contact with the enzyme myrosinase, which is located within the tissues of the plant. Damage to these plants and allows the enzyme into contact glucosinolates, hydrolyzing, leading to the production of toxic substances mainly isothiocyanates and nitriles. Glucosinolates differ among species and cultivations of Brassicaceae and its concentration varies, and, therefore, the biological activity of the glucosinolates will depend on the type and concentration.

Currently, agriculture is driving the development of new cutting edge technologies that solve the problems of pests and diseases and the need to absorb nutrients and water. Disclosed herein are naturally derived nematicide compositions that is effective against a variety of nematodes and can be applied to a variety of economically valuable crops.

This new technology makes practical, simple, efficient, and much less polluting agricultural products. It is also more competitive, allowing savings in production and marketing costs and increasing sales. This in turn enables business innovation in sustainable agricultural as it will reduce the use of chemicals.

Biopesticides are products containing a microorganism active ingredient or plant extracts which are extracted by procedures which do not alter its chemical composition. Biopesticides may comprise all or at least some of a suitable nematicide composition. One advantage of the biopesticides of the present disclosure is that they tend to have less of an environmental impact when applied to crops to treat for nematodes.

According to some embodiments, the preparation of a nematicide utilizes plant extracts that are allelopathic and antagonistic to nematodes and involve a number of compounds including, but not limited to, polyethylenes, glucosinolates, glycosides, alkaloids, lipids, saponins, catechins, terpenoids, steroids, phenols, and triterpenoids. The formulations of some embodiments comprise a mixture of two plant extracts in defined proportions for controlling parasitic phytonematodes.

The procedure for preparing a nematicide composition according to the present disclosure may begin the gathering and quarantining of the raw material for a period of time, such as four days, for quality assurance purposes. The raw material may be tested to verify the minimum and maximum content of the active ingredients of each material, any evidence of interaction with specific formulation ingredients and pH. If the raw ingredients are found suitable for use, they can be labeled and released for use in the formulations of the present disclosure.

To prepare a nematicide composition or emulsion, each of the raw ingredients may be metered or weighed, taking a series of measurements using granular volumetric containers. With each of the ingredients measured, they may be pre-mixed and the premixes measured to achieve desired quantities, volumes, weights, and/or concentrations according to the desired final product. In some embodiments, the ingredients are mixed based on their respective reactivity, first mixing the less reactive ingredients and then adding more reactive ingredients. In some embodiments, the more reactive ingredients are mixed first. Maintaining the stability of each ingredient, each mixture, or each premix can be very important. In some embodiments, the moment when everything is combined is the moment where the stability of the suspension is achieved. Accordingly, proper mixing at each stage can be very important.

According to some embodiments, the following steps are performed to obtain a suitable emulsion or composition:

(1) Provide a homogenizing agent;

(2) Add a base thickening agent;

(3) Agitate;

(4) Add an active ingredient;

(5) Agitate;

(6) Add an emulsifying agent;

(7) Agitate;

(8) Add a second active ingredient; and

(9) Stir;

In some embodiments, the above steps are used to achieve an emulsion having any suitable volume though the quantity may be large enough to suitably treat a significant number of crops affected by or at risk of being affected by nematodes. In some embodiments, mixtures of many liters may be produced, such as 200, 300, 400, 500, or even 1000 liters.

The homogenizing agent or homogenizer of step (1) may be aqueous-based and may comprise water, such as a demineralized water. The homogenizer may comprise from about 1% to about 99% by volume of the total emulsion. In some embodiments, the homogenizer comprises from about 60% to about 90%, about 70% to about 80%, or about 73% to about 79% of the total emulsion. In some embodiments, the homogenizer comprises about 73.75% to about 78.76% of the total emulsion.

The thickening agent or base thickener of step (2) may comprise a thickener such as xanthan gum. Other thickeners that could be used can based on polysaccharides or proteins. Polysaccharide-based thickeners can include starches, vegetable gums, and pectin. Suitable starches can include fecula, arrowroot, cornstarch, katakuri starch, potato starch, sago, tapioca, and derivatives of these starches. Suitable vegetable gums can include alginin, guar gum, and locust bean gum. Protein-based thickeners can include collagen, egg whites, furcellaran, and gelatin. The thickener in some embodiments may comprise from about 0.05% to about 2% by volume of the total emulsion. In some embodiments, the thickener comprises from about 0.8% to about 1.5%, about 0.9% to about 1.0%, or about 0.1% to about 0.6% of the total emulsion.

The agitation of step (3) may be continuous or non-continuous. The agitation may be performed for at least one minute or for less than about one hour. The agitation may involve vibrational movements of the container or spinning the container. In some embodiments, the container (and the mixture contained therein) is spun for about 5-30 minutes at a speed of about 1000-2500 rpm. In some embodiments, the container is spun for about 10 minutes at about 1770 rpm. In some embodiments, agitation is continued until partial, complete, or nearly complete hydration of the hydrocolloid is achieved.

The active ingredient of step (4) may be, in some embodiments, the only active ingredient, or it may be one of multiple active ingredients. Accordingly, the active ingredient in this step is referred to as the first active ingredient even though it may be the only active ingredient. (See the discussion regarding step (8) for more information regarding other active ingredients). In some embodiments, the first active ingredient is at least one of the following: a saponin (e.g. triterpene saponins) and a catechol. In some embodiments, the first active ingredient is derived from a plant extract. Suitable plants can include Larrea tridentata. According to some embodiments, the first active ingredient may comprise from about 5% to about 25% by volume of the total emulsion. In some embodiments, the first active ingredient comprises from about 10% to about 15%, from about 11% to about 14%, from about 12% to about 13%, or from about 12.48% to about 12.53% of the total emulsion.

The agitation of step (5) may be continuous or non-continuous. The agitation may be performed for at least one minute or for less than about one hour. The agitation may involve vibrational movements of the container or spinning the container. In some embodiments, the container (and the mixture contained therein) is spun for about 5-30 minutes at a speed of about 1000-2500 rpm. In some embodiments, the container is spun for about 10 minutes at about 1770 rpm. In some embodiments, agitation is continued until partial, complete, or nearly complete integration of the mixture is achieved.

The emulsifying agent or emulsifier of step (6) may comprise one or more emulsifying agents and may further include agitation between the addition of each emulsifying agent. If agitation is applied between each emulsifying agent, it may be performed for at least one minute or for less than about one hour. The agitation may involve vibrational movements of the container or spinning the container. In some embodiments, the container (and the mixture contained therein) is spun for about 5-30 minutes at a speed of about 1000-2500 rpm. In some embodiments, the container is spun for about 10 minutes at about 1770 rpm. In some embodiments, agitation is continued until partial, complete, or nearly complete integration of the mixture is achieved.

In some embodiments, one or more of the following synthetic emulsifiers is used: polysorbate 80, monostearate Sorbitol, tragacanth, sodium lauryl sulfate, sodium dioctyl sulfosuccinate, polymers known as the Spans® and Tweens®, cationic emulsifiers such as benzalkonium chloride and benzethonium chloride, anionic emulsifiers—such as alkali soaps (e.g., sodium or potassium oleate), amine soaps (e.g., triethanolamine stearate), detergents (e.g., sodium lauryl sulfate, sodium dioctyl sulfosuccinate, sodium docusate)—nonionic emulsifiers including sorbitan esters (e.g., Spans®), polyoxyethylene derivatives of sorbitan esters (e.g., Tweens®), or glyceryl esters. Natural emulsifiers may also be used. Such emulsifiers can include hydrocolloid emulsifiers that can be classified as vegetable derivatives (e.g., acacia, tragacanth, agar, pectin, carrageenan, lecithin), animal derivatives (e.g., gelatin, lanolin, cholesterol), semi-synthetic agents (e.g., methylcellulose, carboxymethylcellulose), synthetic agents, e.g., Carbopols®.

A variety of fatty acids (e.g., stearic acid), fatty alcohols (e.g., stearyl or cetyl alcohol), and fatty esters (e.g., glyceryl monostearate) may also be used to stabilize emulsions through their ability to thicken the emulsion. Because these agents may have only weak emulsifying properties, they may be used in combination with other emulsifiers. Suitable combinations can include the following glyceryl monostearate with glyceryl monostearate, PEG 400 monoleate with polyoxyethylene monooleate, PEG 400 monostearate with polyoxyethylene monostearate, PEG 400 monolaurate with polyoxyethylene monolaurate, potassium oleate with potassium oleate, sodium lauryl sulfate with sodium lauryl sulfate, sodium oleate with sodium oleate, Span® 20 with sorbitan monolaurate, Span® 40 with sorbitan monopalmitate, Span® 60 with sorbitan monostearate, Span® 65 with sorbitan tristearate, Span® 80 with sorbitan monooleate, Span® 85 with sSorbitan trioleate, triethanolamine oleate with triethanolamine oleate, Tween® 20 with polyoxyethylene sorbitan monolaurate, Tween® 21 with polyoxyethylene sorbitan monolaurate, Tween® 40 with polyoxyethylene sorbitan monopalmitate, Tween® 60 with polyoxyethylene sorbitan monostearate, Tween® 61 with polyoxyethylene sorbitan monostearate, Tween® 65 with polyoxyethylene sorbitan tristearate, Tween® 80 with polyoxyethylene sorbitan monooleate, Tween® 81 with polyoxyethylene sorbitan monooleate, and Tween® 85 with polyoxyethylene sorbitan trioleate,

According to some embodiments, the emulsifying agent may comprise from about 0.1% to about 10% by volume of the total emulsion. In some embodiments, the emulsifying agent comprises from about 0.2% to about 7%, from about 0.4% to about 5%, or from about 0.6% to about 3.1% of the emulsion.

In some embodiments in which the emulsifying agent comprises at least two emulsifying agents, the first emulsifying agents may comprise from about to 0.1% to about 5%, from about 0.4% to about 2%, from about 0.5% to about 1%, or from about 0.5% to about 0.7% by volume of the total emulsion. In some embodiments, the first emulsifying agent comprises from about 0.6% to about 0.65% of the total emulsion. The second emulsifying agent, in some embodiments, may comprise from about 1% to about 6%, from about 1.5% to about 4%, or from about 2% to about 3% by volume of the total emulsion. In some embodiments, the second emulsifying agent comprises from about 2.36% to about 2.41% of the total emulsion. In some embodiments, the first and second emulsifying agents comprise, respectively, from about 0.6% to about 0.65% and from about 2.36% to about 2.41% by volume of the total emulsion. According to some embodiments, the first emulsifying agent comprises polysorbate (e.g., polysorbate 80) and the second emulsifying agent comprises monostearate sorbitol.

The agitation of step (7) may be continuous or non-continuous. The agitation may be performed for at least one minute or for less than about one hour. The agitation may involve vibrational movements of the container or spinning the container. In some embodiments, the container (and the mixture contained therein) is spun for about 5-30 minutes at a speed of about 1000-2500 rpm. In some embodiments, the container is spun for about 10 minutes at about 1770 rpm. In some embodiments, agitation is continued until partial, complete, or nearly complete integration of the emulsifying agent(s) into the mixture is achieved.

The active ingredient of step (8), or second active ingredient, may comprise a glucosinolates. Suitable glucosinolates can include aliphatic glucosinolates (e.g., those derived from methionine, alanine, leucine, isoleucine, or valine), and aromatic glucosinolates (e.g., indolic glucosinolates, glucobrassicin, and sinalbin). In some embodiments, the glucosinolates is derived from a plant extract. Suitable plants from which to obtain an extract can include Brassica Sp. The second active ingredient, in some embodiments, may comprise from about 1% to about 15%, from about 3% to about 10%, from about 5% to about 8%, or from about 6% to about 7% by volume of the total emulsion. In some embodiments, the second active ingredient comprises from about 6.2% to about 6.25% of the total emulsion. According to some embodiments, the ratio of the volumes of the first and second active ingredients is from about 30:1 to about 1:10, from about 20:1 to about 1:5, or from about 10:1 to about 1:3. In some embodiments, the ratio is from about 3:1 to about 1:1, and in some embodiments, the ratio is about 2:1.

The stirring of step (9) may be continuous or non-continuous. The stirring may be performed for at least one minute or for less than about one hour. In some embodiments, stiffing is performed for about 5-30 minutes at a speed of about 1000-2500 rpm. In some embodiments, stirring lasts for about 15 minutes at about 1770 rpm. In some embodiments, stirring is continued until partial, complete, or nearly complete formation of an emulsion occurs. The finished product may be stored in non-airtight, translucent containers. According to some embodiments of the present disclosure, the finished product is sometimes referred to herein as Vermitrol®.

While one method of preparing an emulsion has been prepared, one skilled in the art will recognize that other methods could easily be performed to achieve a similar emulsion. For example, some of the outlined steps could be performed in a different order, such as the first step, which could be provided at the end so as to reduce the volume of the mixture that must be agitated between steps.

### EXAMPLE 1

### In Vitro Evaluation of Nematicide Activity

There is a wealth of experience gained in the last few decades to evaluate nematicides and select those compounds that are good candidates for their activity against these parasites, although the conduct or actions to achieve success in this work are somewhat different from those carried out with the insecticides

Exploratory searches for candidate compounds to serve as nematicides had typically been confined to one or a few rare species of parasitic nematodes, Meloidogyne incognita being the organism most frequently used, both in laboratory tests and in the field when analyzing the nematicide effect. This could be because it is the parasitic nematode associated with the highest number of plants. It is estimated to affect over 2000 different plants, both cultivated and wild.

In this example, the response under laboratory conditions in a series of mixtures of ingredients is analyzed to determine which of compound promises better control.

### Materials Used

The six formulations or blind samples were identified by numbers 22, 23, 26, 27, 28 and 30. Each formulation, contained in one liter bottles, had a consistency similar to gel or pasta. Each one also exhibited a characteristic odor. Although unknown to those who conducted this example, samples 22 and 28 were nematicide emulsions prepared according to the present disclosure.

### Methods

With each of the samples, a dilution of 1:10 was prepared. Other dilutions (e.g, 1:50, 1:100, 1:200, 1:400, 1:500, 1:1000, and 1:2000) were also made. A portion of each dilution was deposited in a Petri dish to which was added 10 nematodes that clearly showed signs (e.g., movement) indicating that they were alive. Each specimen was monitored not only for how long it lived but also the rate at which it appeared to die (again based on its movements). If a specimen stopped moving, it was placed in a petri dish filled with pure water after which, if it started moving again, it was placed back into the first petri dish containing the test sample.

The first tests were performed using larvae or juveniles of the Meloidogyne nematode. These specimens were very sensitive and often died very quickly and would even die during the process of transferring them between different petri dishes. Because of their high sensitivity, the Meloidogyne nematodes were replaced with Rhabditida nematodes, specifically those of the Cephalobidae Rhabditidae family, under the hypothesis that the survival of free-living nematodes, as in the case of these bacteriophages, differs from the parasitic. This hypothesis is supported by research from the University of Rhode Island, where it was shown that Rhabdítida nematodes needed 10 times the concentration of a toxic substance to die than was required to eliminate parasitic nematodes (M. Browning et al., Differential Effects of Butyric Acid on Nematodes from Four Trophic Groups, APPLIED SOIL ECOLOGY 27(1), 47-54 (2004).

The Rhabditida nematodes, because they are more resilient, allow for a better analysis of the effect of a range of concentrations on mortality rates. And determining which concentrations will produce a desirable mortality rate, it can be assumed that greater or equal mortality rates will be achieved with other nematodes that are less resilient. The difference in tolerance to a chemical compound can be a good key to eliminate parasitic nematodes without affecting the other plants or animals, considering that they usually play a beneficial role in the soil.

### Results

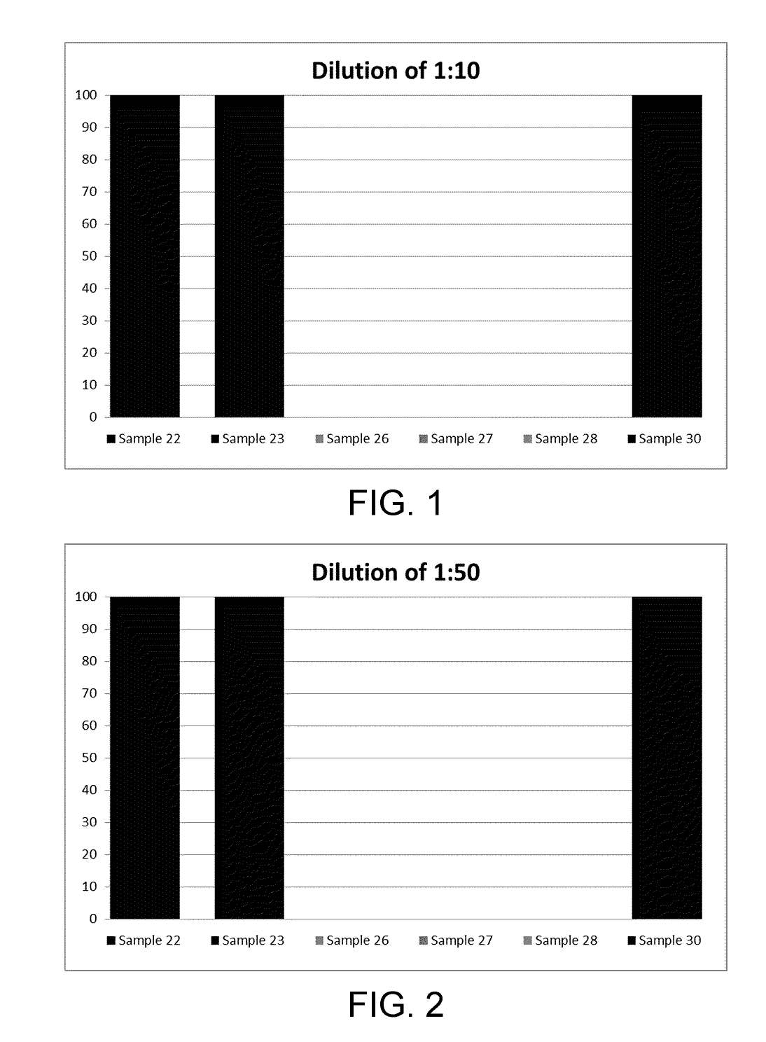

Illustrated in FIGS. 1-7 are the results for each sample. It should be noted that the more detailed observations were made within the first hour to see if that time period produced the greatest effect. If nothing occurred in the first hour, the test material was discarded.

### Dilution of 1:10

At this concentration, it was only possible to test samples 22, 23, and 30. In all cases the effect of complete mortality was achieved in minutes, although with a large difference between sample 22 and the other two, since they took over half an hour, while sample 22 required only 6 minutes. A graphical representation of these results is shown in FIG. 1.

| SAMPLE | EFFECTIVENESS | TIME |
|---|---|---|
| 22 | 100 | 6 min |
| 23 | 100 | 40 min |
| 26 | — | — |
| 27 | — | — |
| 28 | — | — |
| 30 | 100 | 35 min |

### Dilution of 1:50

As in the previous test, the same samples were used, and at this dilution or concentration, the all the nematodes were killed in the same samples but with a much greater contrast against the sample 30. A graphical representation of these results is shown in FIG. 2.

| SAMPLE | EFFECTIVENESS | TIME |
|---|---|---|
| 22 | 100 | 15 min |
| 23 | 100 | 65 min |
| 26 | — | — |
| 27 | — | — |
| 28 | — | — |
| 30 | 100 | 11 hr 40 min |

### Dilution of 1:100

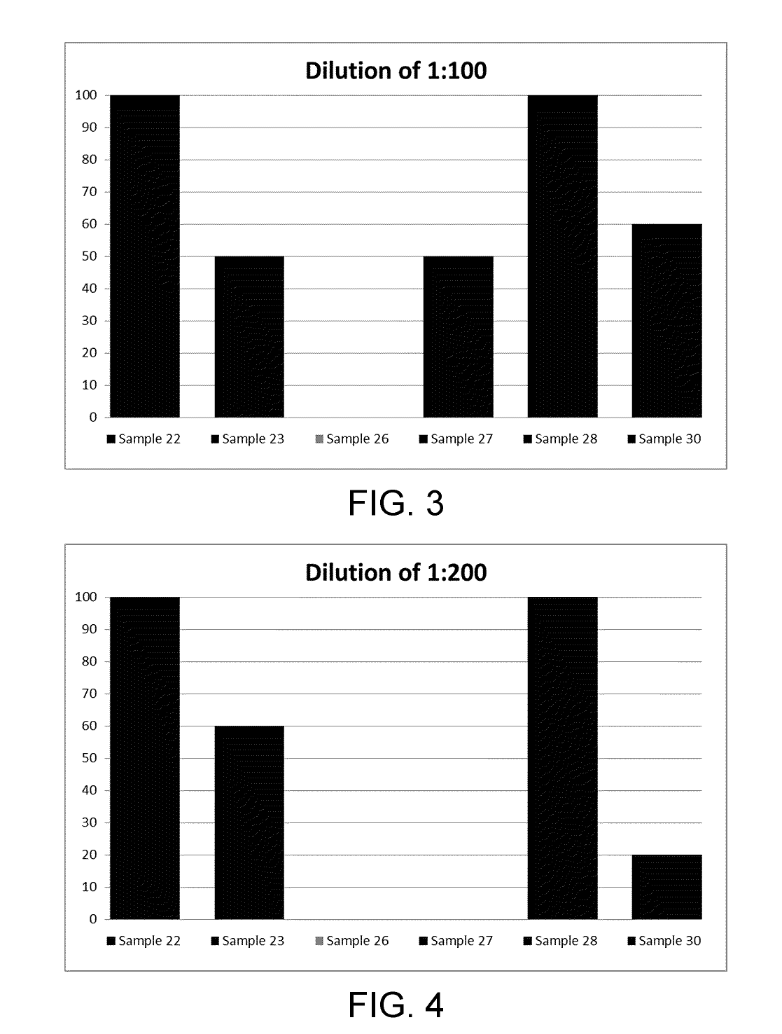

In this case it was possible to test all formulations except sample 26. Again sample 22 had the best performance, which killed all the nematodes in 25 minutes. Sample 23, in the first hour and 20 minutes, killed only half of the nematodes; the testing of this sample was terminated because of a supernatant that blocked the tester's view of the nematodes. Sample 27 needed 23 hours to kill 50% of the nematode. Testing for this sample was also stopped at that point because a layer of oil developed that did not permit the bottom of the petri dish to be viewed. Regarding sample 28, even though no dead nematodes were observed for dilutions of 1:10 or 1:50, a dilution of 1:100 was seen as promising as this formulation killed at least some of the nematodes in less than 3 hours. Sample 30 achieved a mortality rate of only 60% after 25 hours. A graphical representation of these results is shown in FIG. 3.

| SAMPLE | EFFECTIVENESS | TIME |
|---|---|---|
| 22 | 100 | 25 min |
| 23 | 50 | 1 hr 20 min |
| 26 | — | — |
| 27 | 50 | 23 hr |
| 28 | 100 | 2 hr 50 min |
| 30 | 60 | 25 hr |

### Dilution of 1:200

Sample 22 effectively killed all the nematodes in 30 minutes. Sample 23 exhibited a mortality rate of 60% at 24 hours. Sample 26 still produced no observable deaths. Sample 27 was not tested at this dilution. Sample 28 continued to exhibit a 100% mortality rate, and the mortality rate of sample 30 dropped to 20%. A graphical representation of these results is shown in FIG. 4.

| SAMPLE | EFFECTIVENESS | TIME |
|---|---|---|
| 22 | 100 | 30 min |
| 23 | 60 | 24 hr |
| 26 | — | — |
| 27 | — | — |
| 28 | 100 | 3 hr 15 min |
| 30 | 20 | 16 hr 35 min |

### Dilution of 1:500

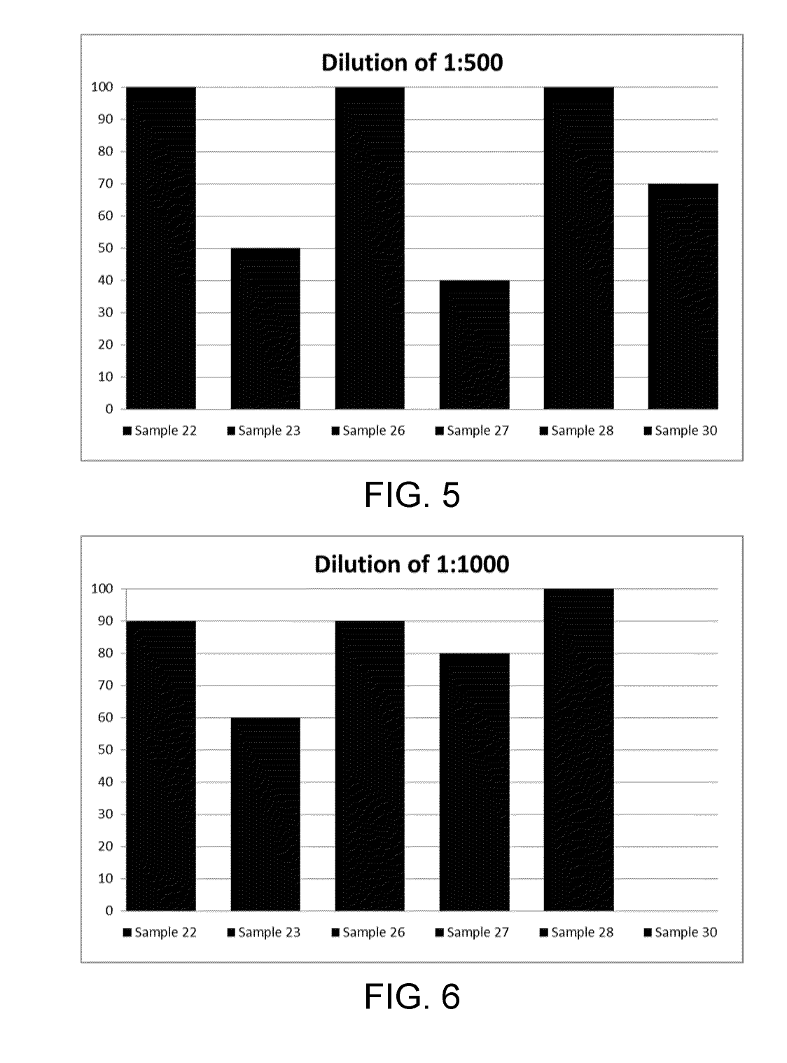

Once again, sample 22 exhibited a mortality rate of 100%. Sample 23 exhibited a mortality rate of 50% after 24 hours. This was the first dilution or concentration of sample 26 that allowed for observable results (i.e., solution clarity allowed for visible observations). And sample 26 achieved a 100% in 2 hours and 30 minutes. Although sample 27 was difficult to observe, it was determined that a mortality rate of 40% was achieved after 21 hours and 10 minutes. Sample 28 achieved a mortality rate of 100% after just 3 hours and 45 minutes. And sample 30, after 56 hours, exhibited a mortality rate of 70%. A graphical representation of these results is shown in FIG. 5.

| SAMPLE | EFFECTIVENESS | TIME |
|---|---|---|
| 22 | 100 | 40 min |
| 23 | 50 | 24 hr |
| 26 | 100 | 2 hr 30 min |
| 27 | 40 | 21 hr 10 min |
| 28 | 100 | 3 hr 45 min |
| 30 | 70 | 56 hr |

### Dilution of 1:1000

In this lowered concentration, sample 22 required 4 hours to achieve a mortality rate of 90%. Sample 23 exhibited a mortality rate of only 60% after 24 hours, while sample 26 achieved 90% in 21 hours. After 26 hours, sample 27 had achieved a mortality rate of 80%, and sample 28 required 10 hours to kill all the nematodes in the petri dish. Regarding sample 30, it was decided that no test would be run at this dilution because of the difficulty in observing the nematodes in the petri dish. However, it should be noted that 10 nematodes were placed in a dish with a measured quantity of sample 30, and 4 of the 10 were still moving after 4 days in the petri dish. A graphical representation of these results is shown in FIG. 6.

| SAMPLE | EFFECTIVENESS | TIME |
|---|---|---|
| 22 | 90 | 4 hr |
| 23 | 60 | 24 hr |
| 26 | 90 | 21 hr |
| 27 | 80 | 26 hr |
| 28 | 100 | 10 hr |
| 30 | — | — |

### Dilution of 1:2000

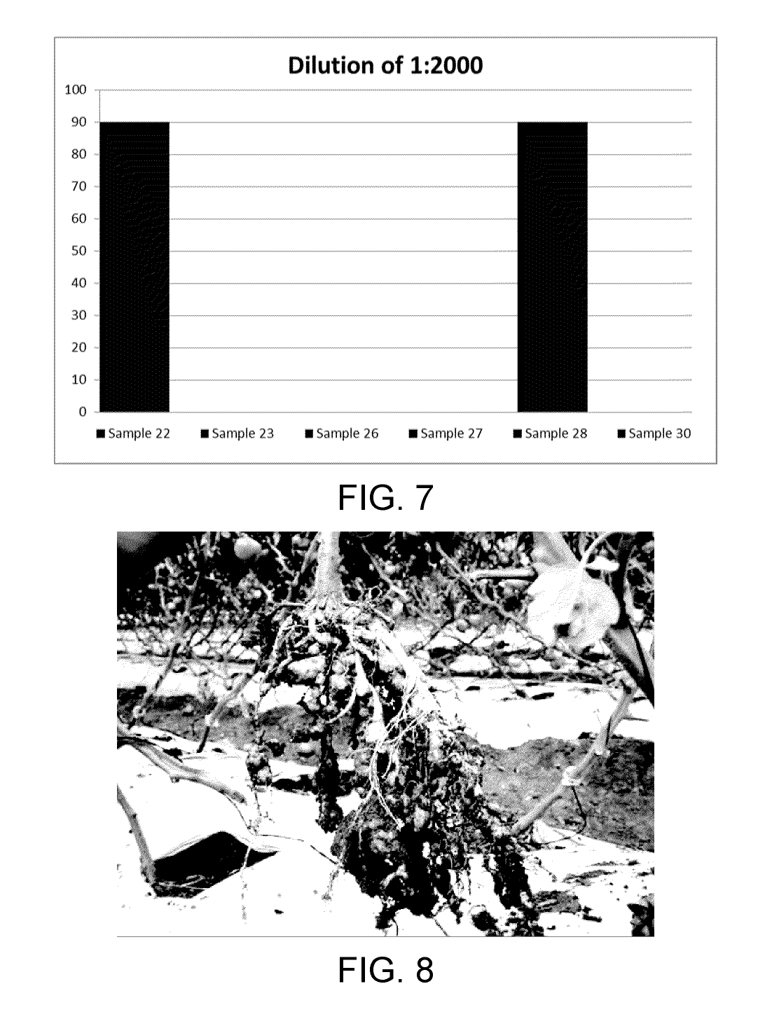

Observations were only made for the sample materials that had, in previous tests, exhibited the highest mortality rates: samples 22 and 28. Both samples in at this diluation achieved a mortality rate of 90% but required 24 hours and 30 hours, respectively. A graphical representation of these results is shown in FIG. 7.

| SAMPLE | EFFECTIVENESS | TIME |
|---|---|---|
| 22 | 90 | 24 hr |
| 23 | — | — |
| 26 | — | — |
| 27 | — | — |
| 28 | 90 | 30 hr |
| 30 | — | — |

In general, it can be concluded that a nematicide is effective if it is able, after a given period of time, of killing at least 80% of a sample population of nematodes. In this example, it was determined that in a period of about 24 hours, desirable results were obtained in about 80% of the tests. It was interesting to note that some nematodes remained alive and active for multiple days. It has been suggested their particularly notable resistance may be the result of genetic mutations caused by previous exposure in other environments to nematicides, pesticides, fertilizers, or other synthetic chemical products.

In the present case, each of the samples would most likely be intended as an emulsifiable concentrate because this one of the most stable formulations. However, some concentrations proved difficult to emulsify because of a lack of homogenization. Agglomerates would form as an oily supernatant at the top of the petri dish. This presents a problem in that any attempt to mix the supernatant into the rest of the fluid in the petri dish could also move or disturb the nematodes at the bottom of the petri dish. Such movement would then further remove the test conditions from any actual conditions in which one would find nematodes. Therefore, three of the six samples were not tested for the dilutions 1:10 and 1:50. And sample 26 was also not tested in the dilutions 1:100, 1:200, and 1:2000. But we note that the dilutions for which sample 26 was tested (1:500 and 1:1000), the results were very promising, but this sample was still thought to perform the third best behind samples 22 and 28.

### Conclusions

Samples 22 and 28 were the most prominent in their behavior with sample 22 even at the highest dilution of 1/2000 showing an effectiveness of 90% at 24 hours and the same percentage of effectiveness in the concentration of 1/1000 in just 4 hours. And sample 28 achieved similar results in 30 and 10 hours, respectively.

Sample 30 was the least effective. It required more time than any other sample to achieve a mortality rate of 100% at a concentration of 1:50, but did exhibit favorable results at the 1:10 concentration. In any case, for the 1:100, 1:200, and 1:500 concentrations, sample 30 simply took too long to achieve desirable mortality rates.

Because samples 22 and 28 achieved the greatest mortality rate, it was concluded that nematicide emulsions prepared according to the present disclosure proved to be a significant advance over other known nematicides.

### EXAMPLE 2

### Biological Effectiveness of Nematicides in Controlling the Root-Knot Nematode (Meloidogyne incognita)

The root-knot nematode (Meloidogyne incognita) has been identified as a major horticultural pest. Some even regard this nematode as having the most impact on many agricultural areas reducing production of a variety of crops. The genus Meloidogyne incognita affects cultivated plants and wild. It is now considered that almost all crops are susceptible to attack. In some places, the affected crops include tomatos, peppers, cucumbers, eggplant, beans, and squash among others.

The evidence of an attack of the root-knot nematode includes stunted growth and yellowing of the leaves. Affected plants exhibit symptoms of water difficiency during the hottest hours of the day even in the presence of adequate irrigation. This is due to the plant's limited ability to absorb water.

Typical symptoms are presented in the root system in which the roots of affected plants are generally short and have little or no side branches. The formation of galls or tumors has also been seen. Such a deteriorated root system is not able to absorb water and nutrients in the soil. Thus, their growth is stunted.

The gills are the outward manifestation of Meloidogyne attack on the radical system, as an increase in cell size (hypertrophy) found near the head of the nematode, and cell multiplication (hyperplasia) that gives rise to the gills. Hypertrophied cells, known as “giant cells,” are what provide the nematode with a nutritional source for its full development and reproduction. FIG. 8 illustrates the roots of an affected plant in which large nodules can be seen that are caused by the presence of nematodes.

This experiment was conducted to evaluate the biological effectiveness of a known nematicides as well as a nematicide prepared according to the present disclosure, known commercially as Vermitrol®, against the root-knot nematode in tomato cultivation under shade net conditions. This research was conducted in the facilities of the Center for Food Research and Development (ICAS) Unit Culiacan in Mexico.

Roots were collected from infected tomato plants (galls) with root-knot nematode (Meloidogyne sp) from a commercial farm, located in the La Palma, Navolato, Sinaloa. Once roots were collected, they were placed in a cooler and transported to the laboratory facilities of Plant Pathology ICAS.

Identification of the species of the genus Meloidogyne, relied primarily on the type of pattern or perineum presented by the female nematodes. From galled roots that were collected, the females were extracted with the help of a dissecting needle and, once selected by size (mature females), these were placed on a piece of wax paper or plastic. And with a new razor, cuts were made at the middle of the nematode eliminating the anterior half of the body. To posterior half, two parallel cuts were made, one on each side of the genital region. Two more cuts were then made that were perpendicular to the first two so as to leave the genital region in a square formed by the cuts. A drop of lactophenol was then placed on a clean microscopic slide and upon this were placed the perineum of the females so that the outer part of the perineum made contact with the slide surface. These were then compared with known samples reported by J. D. EISENBACK ET AL., A GUIDE TO THE FOUR MOST COMMON SPECIES OF ROOT-KNOT NEMATODES (MELIDOGYNE SPP.) WITH A PICTORIAL KEY (1981).

The roots showing signs of galls were washed thoroughly with tap water and then cut into small pieces, placed in a blender cup with 400 ml of distilled water, and comminuted at low speed for 30 seconds. The crushed material was passed through a strainer or sieve 100 and a mesh having 325 openings per square inch, and finally the eggs retained in another 500 openings per square inch. The material obtained in the 500 sieve, collected in a beaker to determine the amount of J₂ and eggs present in the suspension by counting with the help of a hematocrit technique (French and Herber, 1980). This procedure was performed repeatedly until achieving a sufficient population size the inoculum test (C. P. DISANZO ET. AL., GUIDELINES FOR EVALUATING NEMATICIDES IN GREENHOUSES AND GROWTH CHANBERS FOR CONTROL OF ROOT-KNOT NEMATODES 114-126 (1978)).

The application of treatments was made directly in each of the test pots, to which was added the product in 400 mL of distilled water—the amount having been previously calibrated on the bottom of the pot—where data on the treatments consisted of dose and range of application (see Table 1).

TABLE 1
Description of treatments (Vermitrol ®) applied
in the control of root-knot nematode vegetables.

| | | | +8 | +21 | +42 | +50 |
|---|---|---|---|---|---|---|
| Treatment | Inoculum | Transplant | DDT | DDA | DDT | DDT |
| Control | N | — | — | | | Eval- |
| | | | | | | uation |
| Vermitrol ® | N | 4 L/ | — | 3 L/ | 3 L/ | Eval- |
| | | hectare | | hectare | hectare | uation |
| QL-Agri | N | 5 L/ | 5 L | 5 L/ | 5 L/ | Eval- |
| | | hectare | | hectare | hectare | uation |
| Vidate L | N | 5 L/ | 5 L | 5 L/ | 5 L/ | Eval- |
| | | hectare | | hectare | hectare | uation |

The evaluation parameters were to quantify or provide a percentage index of the galling for each of the plants in each treatment after 50 days of applying a nematicide product. Each plant was cut at the base, and the roots of each plant were extracted very carefully from the pots and immediately were washed with tap water and disinfected with chlorine. They were then subjected to the staining process Acid Fuchsin (the dye solution is prepared by dissolving 3.5 g of fucsina acid in 250 mL of acetic acid and 750 mL of distilled water). The staining material had been boiled beforehand for 1 min and allowed to cool at room temperature. It was then applied to tomato roots to quantify the presence of galls, which served as a reference hedonic scale providing arbitrary values of 0 to 5, where: 0 meant 0% galling at the root, 1 meant from 1% to 10% galling at the root, 2 meant 11% to 25% of roots galled; 3 meant 25% to 50% of roots galled, 4 equaled 51% to 75% of roots galled, and 5 equaled 76% to 100% of root galling (K. G. BAKER ET AL., METHODS FOR EVALUATING PLANT FUNGICIDES, NEMATICIDES, AND BACTERICIDES 114-126 (1978)).

To determine the effectiveness of the treatments, the results of the index galls were subjected to the following formulas: percentage of the galling severity and percentage of biological effectiveness.

The formula for the percentage of galling severity is given as follows:

$$G S \% = \frac{( G {I}_{1} ) + ( G {I}_{2} ) + … + ( G {I}_{5} )}{Total number of test plants} \times 100 \%$$

where:
GS % is the percentage of the galling severity;
GI₁ is the number of plants given a galling index of 1;
GI₂ is the number of plants given a galling index of 2; and
GI₅ is the number of plants given a galling index of 5.

The formula for the percentage of biological effectiveness is given as follows:

$$\% Effectiveness = \frac{G C - S T}{G C} \times 100 \%$$

where:
GC is the number of plants in the control group of plants exhibiting galling; and
ST is the number of successfully treated plants, those whose galling was significantly reduced by virtue of the tested treatment.

A statistical analysis was performed to measure the variance between the various test samples. The averages were also compared using the Tukey test at 0.5.

The populations of female nematodes Meloidogyne spp in the study identified based on the perineum pattern where the population of adult females presented the high dorsal arch formed by grooves that ranged from smooth to wavy without clearly visible sidelines. These characteristics were similar to those reported in EISENBACK supra.

Regarding the galling severity, no significant differences were found between the various test compounds when comparing their respective averages, but when compared to the control group, all treatments were found to be superior. Nevertheless, the treatment that presented the lowest galling severity was Vermitrol® at a dosage of 10 L/hectare (separated into three separate applications) with a galling severity of 4.0% and an 82.6% biological effectiveness. QL-Agri, at a dosage of 5 L/hectare applied every seven days (for a total of five applications) achieved a galling severity of 6.0% and a biological effectiveness of 73.9%. In third place, Vidate L, at a dosage of 5.0 L/hectare, applied every seven days (for a total of five applications) achieved a galling severity of 7.0% and a biological effectiveness of 69.5%. These results are shown in Table 2 below.

TABLE 2
Comparison of test compounds

| TREATMENT | Galling | % Biological |
|---|---|---|
| AND DOSE | Severity | Effectiveness |
| 1. Control | 23.0% | — |
| 2. Vermitrol ® | 4.0% | 82.6 |
| 3. QL-Agri | 6.0% | 73.9 |
| 4. Vidate L | 7.0% | 69.5 |

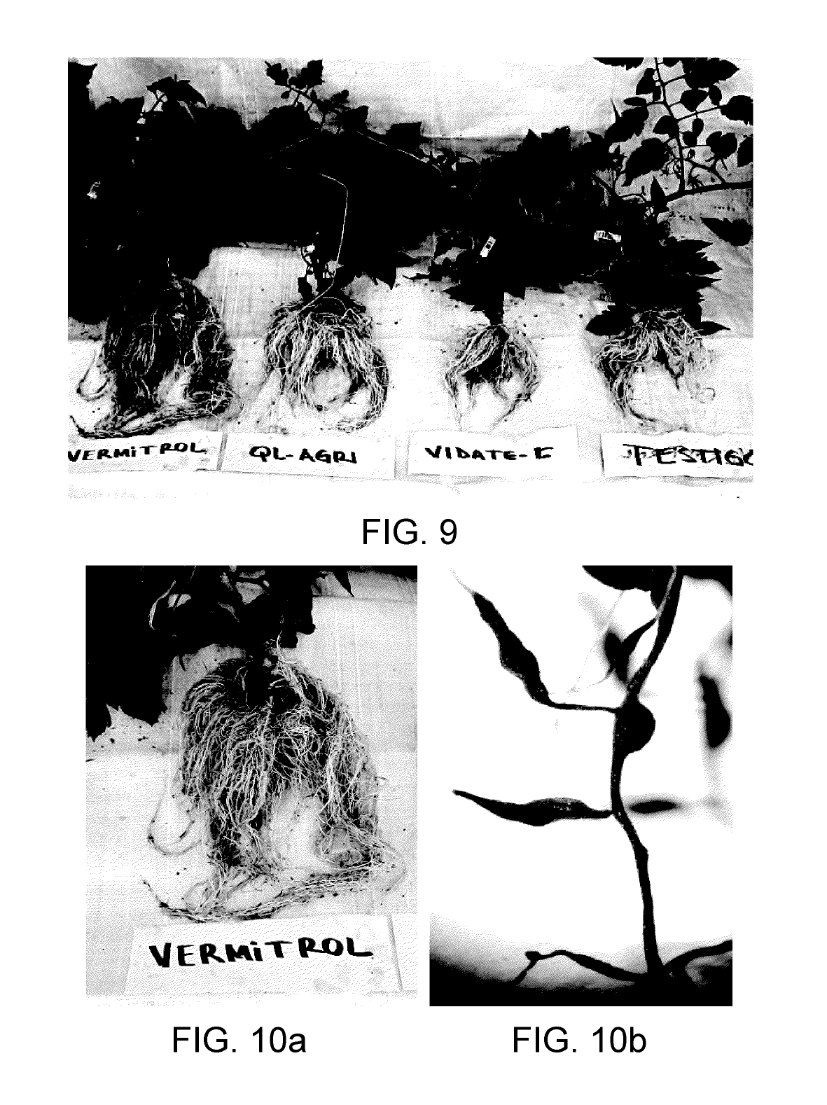

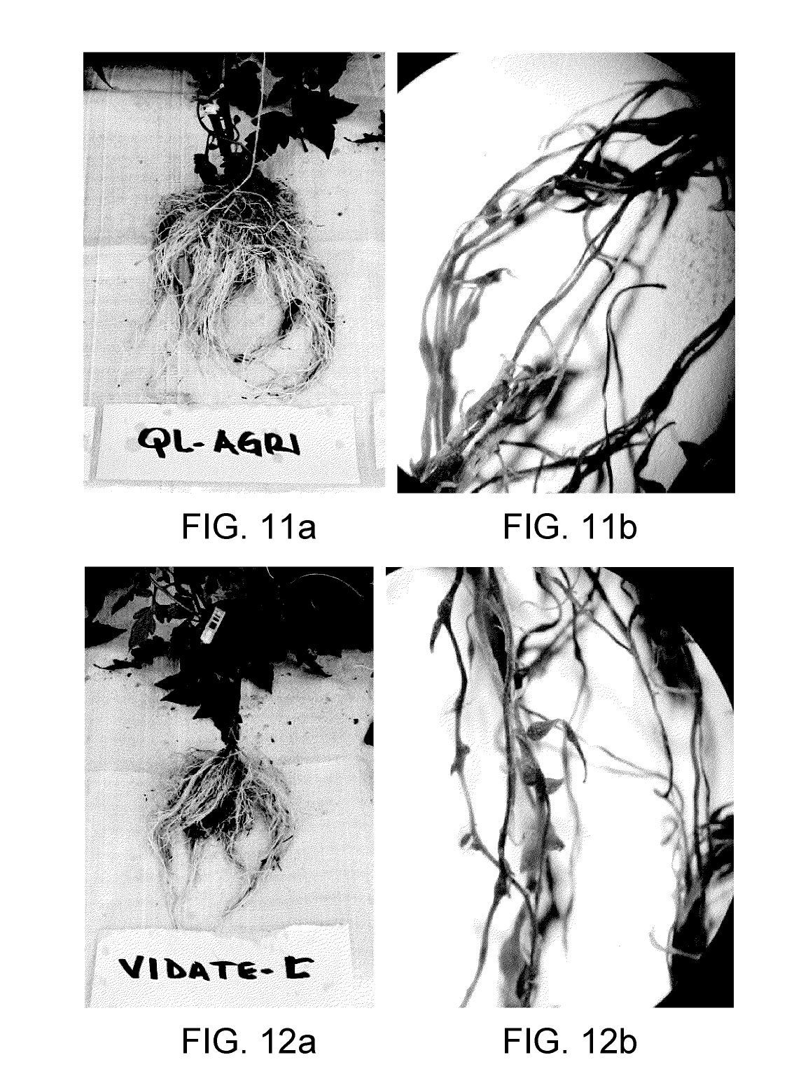

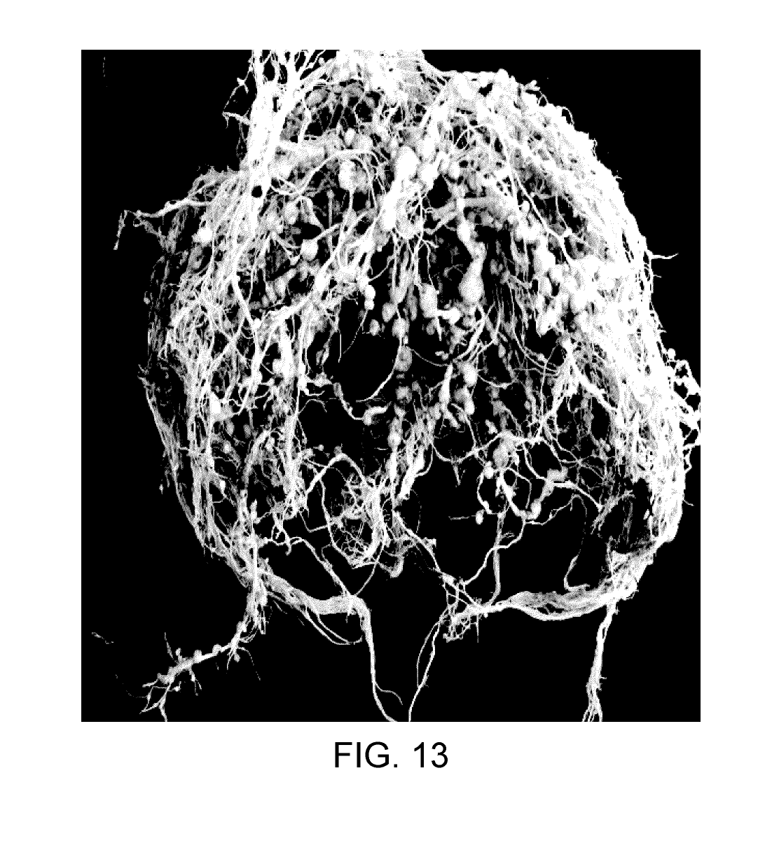

FIG. 9 is a photograph of the roots of four different tomato plants, one from each of the test groups (where the plant labeled “testigo” is from the control group). It can be seen that the roots treated with Vermitrol® appear to the most vibrant and least stunted in their growth. FIG. 10a is a photograph of just the roots treated with Vermitrol®, and FIG. 10b is an image of the same roots but after a die has been applied for better visualization. FIG. 11a is a photograph of just the roots treated with QL-Agri, and FIG. 11b is an image of the same roots after a die has been applied for better visualization. FIG. 12a is a photograph of just the roots treated with Vidate L, and FIG. 12b is an image of the same roots after a die has been applied for better visualization. FIG. 13 is a photograph of the roots of a plant from the control group that did not receive any nematicide treatment. Accordingly, the roots are covered by a large number of nodules or growths.

It will be understood by those of skill in the art that numerous and various modifications can be made without departing from the spirit of the present invention. Therefore, it should be clearly understood that the forms of the present invention are illustrative only and are not intended to limit the scope of the present invention. All modifications and changes are intended to fall within the scope of the invention, as defined by the appended claims.

What is claimed is:

1. A nematicidic emulsion, the emulsion comprising:
water;
a base thickener;
an emulsifying agent;
saponins and catechols; and
glucosinolates, wherein the ratio of amount of saponins and catechols to glucosinolates is in the range from 20:1 to 1:5.

2. The emulsion of claim 1, wherein the water comprises from about 1% to about 99% of the total volume of the emulsion.

3. The emulsion of claim 1, wherein the base thickener comprises about 0.01% to about 6.0% of the total volume of the emulsion.

4. The emulsion of claim 1, wherein the base thickener comprises xanthan gum.

5. The emulsion of claim, wherein the emulsifying agent comprises a first emulsifying agent and a second emulsifying agent.

6. The emulsion of claim 5, wherein the first emulsifying agent comprises about 0.05% to about 6% of the total volume of the emulsion.

7. The emulsion of claim 5, wherein the first emulsifying agent comprises polysorbate 80.

8. The emulsion of claim 5, wherein the second emulsifying agent comprises about 0.2% to about 25% of the total volume of the emulsion.

9. The emulsion of claim 5, wherein the second emulsifying agent comprises monostearate sorbitol.

10. The emulsion of claim 1, wherein the glucosinolates comprise about 0.5% to about 60% of the total volume of the emulsion.

11. The emulsion of claim 1, wherein the saponins and catechols comprise about 1.0% to about 90%.

12. A packaged emulsion, comprising
a non-air tight, translucent enclosure; and
the emulsion of claim 1 packaged inside the enclosure.

13. The emulsion of claim 1 further comprising at least one selected from the group consisting of: polyethylenes, other glycosides, other alkaloids, lipids, catechins, terpenoids, steroids, phenols, and triterpenoids.

14. The emulsion of claim 13, wherein the emulsion further comprises nordihydroguaiaretic acid (NDGA).

15. The emulsion of claim 1, wherein the saponin comprises triterpene saponin.

16. The emulsion of claim 1, wherein the saponin is present in a first plant extract.

17. The emulsion of claim 16, wherein the first plant extract is an extract of Larrea tridentata.

18. The emulsion of claim 1, wherein the glucosolinates are present in a second plant extract.

19. The emulsion of claim 18, wherein the second plant extract is an extract of Brassica Sp.

20. The emulsion of claim 1, wherein the base thickener comprises xanthan gum.

21. The emulsion of claim 1, wherein the first emulsifying agent comprises polysorbate.

22. A method of making a nematicidic emulsion according to claim 1, wherein the emulsifying agent comprises a first emulsifying agent and a second emulsifying agent, the method comprising:
providing water;
adding the base thickener to the water to form a first mixture;
agitating the first mixture;
adding the saponins and catechols to the first mixture to form a second mixture;
agitating the second mixture;
adding the first emulsifying agent to the second mixture to form a third mixture;
agitating the third mixture;
adding the second emulsifying agent to form a fourth mixture;
agitating the fourth mixture until the fourth mixture is substantially homogenous;
adding the glucosinolates to the fourth mixture to form a fifth mixture; and
stirring the fifth mixture until the emulsion is formed.

23. The method of claim 1, wherein agitation is continuously applied.

24. The method of claim 1, wherein agitating of each of the first, second, third and fourth mixtures is performed for about 0.5 to about 50 minutes at about 100-10,000 rpm.
